(19) United States
(12) Patent Application Publication
(10) Pub. No.: US 2009/0328160 A1
(43) Pub. Date: Dec. 31, 2009

(54) ADMINISTRATION PORTAL

(75) Inventor: Mark Crispin Webb-Johnson, Kowloon (CN)

Correspondence Address: SEED INTELLECTUAL PROPERTY LAW GROUP PLLC, 701 FIFTH AVE, SUITE 5400, SEATTLE, WA, 98104, US

(73) Assignee: NETWORK BOX CORPORATION LIMITED, Kowloon (CN)

(21) Appl. No.: 12/433,699

(22) Filed: Apr. 30, 2009

Related U.S. Application Data
(63) Continuation-in-part of application No. PCT/IB2007/003317, filed on Nov. 2, 2007.

(30) Foreign Application Priority Data
Nov. 3, 2006 (AU) 2006906147

(51) Int. Cl. H04L 29/06

(52) U.S. Cl. 726/4

(57) ABSTRACT

An administration portal for a network security server, including: (i) control elements allowing a user of a network to access respective services, such as email, spam filter, malware filter, and web browser control services, performed by the security server; and (ii) an administration module for maintaining permission attributes for users of the network, the attributes defining access to the control elements. The permission attributes have a delegation hierarchy so a managed security service provider can set a permission attribute for a user to administrator, and the user with an administrator permission attribute can set another user to have a user permission attribute. The permission attributes can also be set on a group basis for a group of said users. The attributes each have associated capability levels defining a level of access for the respective services.

### BACKGROUND

1. Technical Field

The present disclosure relates to an administration portal for a network security system.

2. Description of the Related Art

Network perimeter security systems are installed at the edge of local and wide area networks of entities to protect the networks from being compromised by external networks. For instance, a connection to the Internet may be protected by a number of machines including a security server connected directly to the Internet to protect against a wide variety of Internet threats, such as viruses, worms, trojans, phishing, spyware, spam, undesirable content and hacking. Configuration files of the security server include signatures or pattern files that are used as a basis to detect the threats and are updated on a regular basis. Given the frequency with which Internet threats change and are created, the security servers are normally updated in a regular and timely manner by a managed security service provider (MSSP) using remote equipment of a central network operations center (NOC).

In addition to controlling the update of the threat signatures, the MSSP may also control other configuration settings of the security servers installed at various locations, in order to maintain the integrity of security servers and their performance. The configuration settings may include the manner in which parameters are set for spam filters or for filters that are used to detect malicious software (“malware”), such as viruses, worms, trojans etc. The MSSP may also control the manner in which spam can be released to terminals in the protected network.

For some networks, however, complete control by the MSSP may be contrary to an entity's security policy, inefficient, or otherwise disadvantageous, for example in instances where a security server is generating false positives, i.e. incorrectly withholding a valid email as an identified threat. Accordingly, it is desired to provide at least a useful alternative and preferably a facility which provides for more flexible configuration and control, without affecting the integrity of the network security system.

### BRIEF SUMMARY

In accordance with one embodiment there is provided an administration portal for a network security server, including:

control elements allowing a user of a network to access respective services performed by said security server; and

an administration module for maintaining permission attributes for users of the network, said attributes defining access to said control elements.

One embodiment provides an administration process for a network security server, including:

allowing a user of a network to access respective services performed by said security server; and

maintaining permission attributes for users of the network, said permission attributes defining access to said services and having a delegation hierarchy;

wherein a managed security service provider can set a permission attribute for a user to administrator, and a user with an administrator permission attribute can set another user to have a user permission attribute.

### BRIEF DESCRIPTION OF THE SEVERAL VIEWS OF THE DRAWINGS

Preferred embodiments of the present disclosure are hereinafter described, by way of example only, with reference to the accompanying drawings, wherein:

FIG. 1 is a block diagram of a preferred embodiment of a security server connected to a local area network (LAN);

FIG. 2 is a diagram of the architecture of a preferred embodiment of a security system;

FIG. 3 is a block diagram of a preferred embodiment of components of a security server of the system;

FIG. 4 is a screen shot of an overview interface of an administration portal of the security server;

FIG. 5 is a screen shot of a mail interface of the administration portal;

FIG. 6 is a screen shot of a further mail interface of the administration portal;

FIG. 7 is a screen shot of a spam interface of the administration portal;

FIG. 8 is a screen shot of a malware interface of the administration portal; and

FIG. 9 is a view of a report message generated by the administration portal.

### DETAILED DESCRIPTION

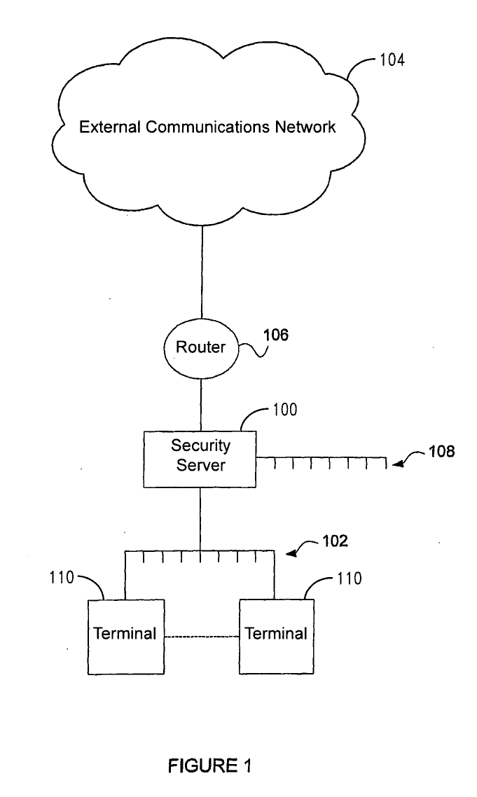

A security server 100, as shown in FIG. 1, provides an Internet threat protection appliance to protect a local area network (LAN) 102 of an entity from a wide variety of Internet threats. The threats include viruses, worms, trojans, phishing, spyware, spam, undesirable content and hacking, and any other form of unwanted code, traffic or activity relevant to the LAN 102. The security server or box 100 is connected directly to an external communications network 104, such as the Internet, by a router 106, thereby being positioned between the LAN 102 and the Internet 104. The LAN 102 connects a number of terminals 110 of the network 102. The terminals 110 are computer devices, such personal computers or telephones, capable of handling network traffic and messages, such as email and hypertext transfer protocol (HTTP) requests and responses. The security server or box 100 may also provide support for a demilitarized zone (DMZ) 108 and, in alternative embodiments, the server 100 may include a number of machines. The box 100 can, for example, be one of the threat protection appliances produced by Network Box Corporation. The network architecture in which the security server 100 is used can vary considerably. For example, a number of LANs or a wide area network (WAN) may be protected by one box 100, or the box 100 may support more than one DMZ.

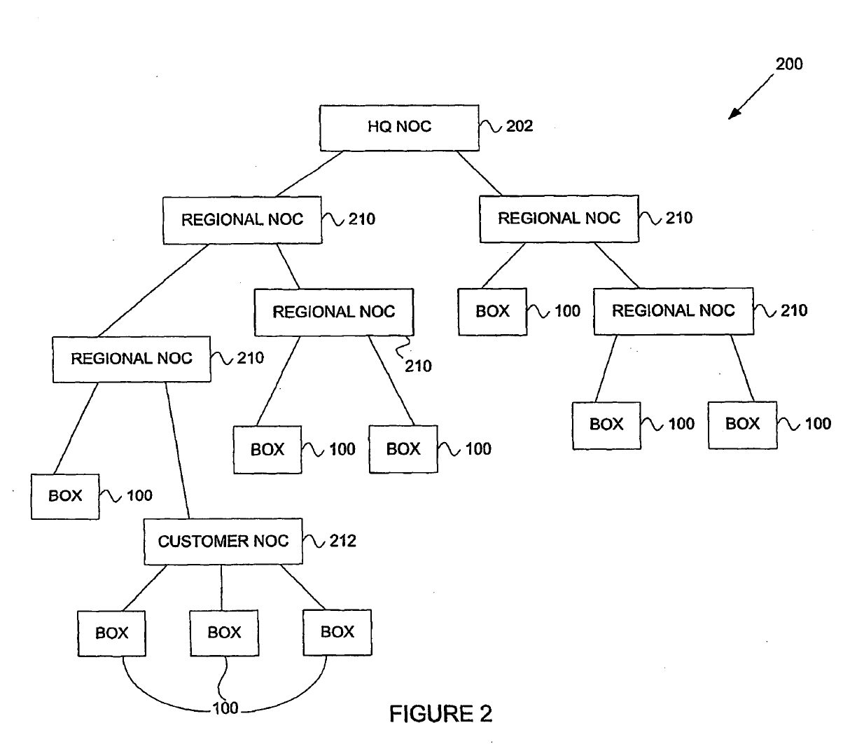

A security system 200, as shown in FIG. 2, includes a number of boxes 100 which are all updated by configuration files delivered from one or more central or headquarters network operations centers (NOC) 202 of a managed security service provider (MSSP). The headquarters NOC 202 provides a root node of the security system 200, and the security boxes 100 are leaf nodes of the security system 200 and are connected in a hierarchy by intervening nodes 210 and 212 of intermediate levels in the hierarchy so that the security system 200 has a tree structure, as shown in FIG. 2. The intervening nodes 210, 212 include regional NOCs 210 allocated to cover a geographic region, such as Australia and New Zealand, and customer NOCs 212 which may be allocated to serve one or more security boxes 100 of an entity. In alternative embodiments, the number of intermediate NOCs 210, 212 may be varied as desired or omitted altogether. The configuration files are delivered from an upstream node (typically, but not always, the root node 202) to downstream nodes (typically the leaf nodes 100) via the intermediate nodes 210 and 212 as updates.

The box 100 and the nodes 202, 210 and 212 each include a central processing unit, volatile memory, permanent storage (e.g. flash memory, hard disk) and at least one network interface card for connection to the public network 104 and local network 102. The box 100 and the nodes 202, 210, 212 can be implemented using general purpose computers. Also, application specific integrated circuit (ASIC) based systems operating with flash memory or other purpose-built hardware can be used.

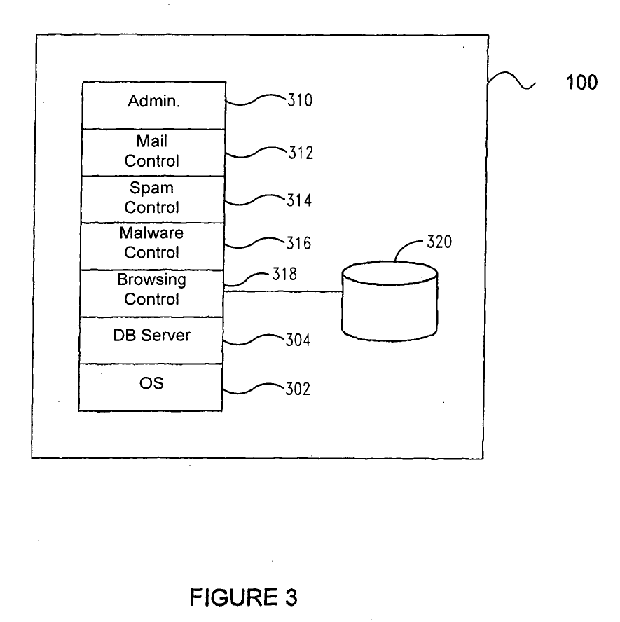

The security server 100, as shown in FIG. 3, includes an administration module 310 and a number of control elements 312, 314, 316 and 318 that provide an administration portal, and which all run on an operating system 302, such as Linux, of the box 100. The administration module 310 and the control elements 312 to 318 have access to and utilize a database 320 maintained by a database server 304, such as MySQL, of the box 100. The administration module 310 is accessible by a NOC 202 of the MSSP, and is used to maintain and adjust tables of permission attributes for all of the users authorized to use a terminal 110 connected to the network 102 of the box 100. A permission attribute is associated respectively with a control element 312 to 318 and defines the ability of a user when validly logged onto a terminal (i.e. authenticated) to access that control element. The control elements 312 to 318 each provide access to respective services or processes performed by the security server 100, and allow adjustment of parameters associated with services and processes performed by the network security system. Associated with a permission attribute for a service are capability attributes defining a level or access to respective services or processes of a service. The attributes are maintained in tables of the database 320.

A mail control element 312 provides access to search and report services. A spam control element 314 provides access to filter, release, search, blacklisting, whitelisting and report services. A malware control element 316 provides access to filter, release (eg to a virus administrator), search and report services. A web browsing control element 318 provides access to HTTP response filter (to block undesired or unauthorized content) and report services. Capability level attributes are associated with the search, report, filter and release services for each control element accessible by a terminal. The capability level attributes each represent a level in range, e.g. from 1 to 10, and control the manner in which a terminal can utilize the services.

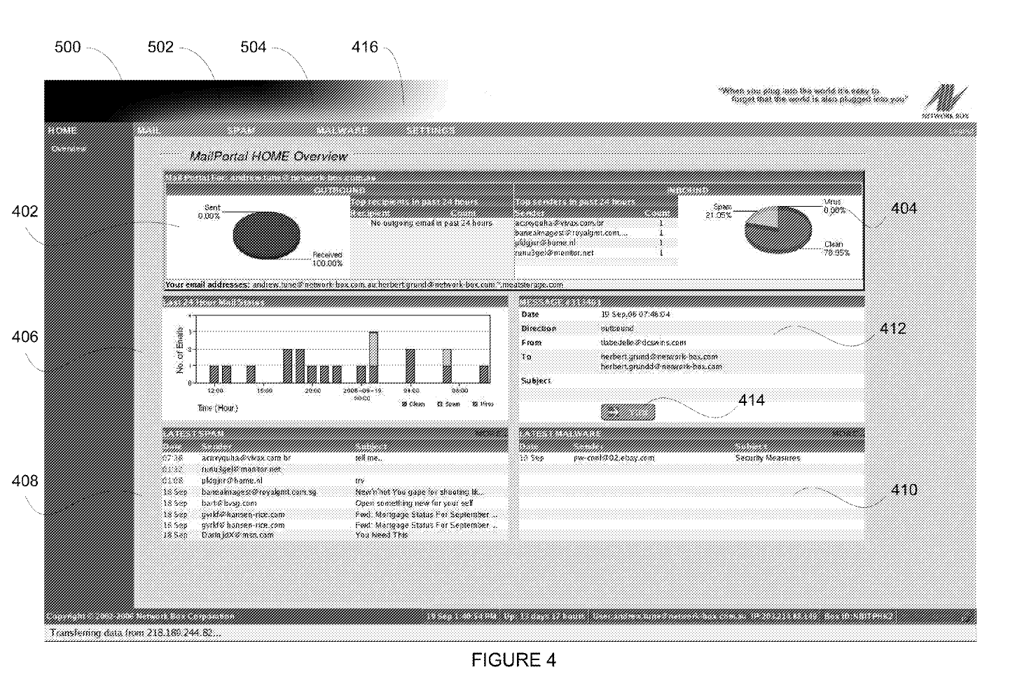

The administration module 310 generates a user interface that can be rendered by a web browser, as shown in FIG. 4. The web browser may be run by a terminal 110 or NOC 202. The interface shown is an overview interface that displays data generated by outbound and inbound report components 402 and 404 and a status report component 406 of the mail control element 312, for mail received in a 24 hour period. Spam and malware reports components 408 and 410 also provide data on the messages that have been received and identified as spam or malware, and are produced by the spam and malware control elements 314 and 316. The reports generated may be for the entire network 102, or individual recipients or users of the network associated with a terminal 102. The interface shown in FIG. 4 in this instance is for a single user, designated by an email address of the network 102. The interface parts generated by the spam and malware report components 408 and 410 allow an individual message to be selected so as to display the meta data for that message in another part 412 of the overview interface. The actual message can be accessed by selecting a view control 414 of the interface.

Initially, the permission attributes for the control elements of a box 100 are set to mssp, which restricts access to the administration module 310, and the control elements to any authorized NOC (e.g. the HQ NOC 202), i.e. the MSSP. The associated capability level attributes for the mssp permission attributes are all set to the highest level. Using a settings control 416 provided on the overview interface, the MSSP can use the administration module 310 to access and adjust the permission attributes and associated capability levels for the control elements. The settings interface of the administration module 310 allows the MSSP to select at least one user of the network 102 and set the permissions attributes for one or more of the control elements to admin. This effectively delegates the services of that control element to the user thereby granting administration rights when logged onto a terminal 110. For example, setting the permission attribute for the mail, spam and malware control elements 312 to 316 to admin for a user, would provide the user's terminal with access to all the components of the interface as shown in FIG. 4. If the malware control element 316 remains at mssp, then the user would not have access to the malware report component 410. The capability levels for each of the services can also be set accordingly for an administrator. For instance, the view control 414 may be made available to provide view access for an administrator, or alternatively the capability level may be set to a lower level so that the view control 414 does not appear, and only the meta data associated with the message can be viewed.

A user associated with a permission attribute of admin for a control element 312 to 318 can then use a terminal 110 to further delegate control for that element to an individual user of a terminal. An mssp user is also able to do this, as any more authoritative party can control the attributes of any less authoritative party. A terminal 110 with an admin permission attribute is able to access the settings interface of the administration module 310 to set the permission attribute to user for selected terminals 110 for the control elements that administration terminal has admin privileges. The control element is then accessible by a terminal granted user privileges. For instance, if the permission attribute for a terminal 110 for the mail, spam and malware control elements 312 to 316 is set to user, then that terminal would have access to the interface shown in FIG. 4. The only difference between the mssp and an admin permission attribute is that no further delegation or adjustment of the permission attribute can be made by a user with a user attribute, and services and processes cannot be performed for more than that user, ie the services and processes are only available for that particular terminal user, e.g. mail reports can only be generated for that user's address. An admin user can also set the associated capability level attributes for a permission attribute it sets to user.

The manner in which attributes and capability levels are assigned, as described above, is defined by a permissions model of the security system 200. In addition to the above, this allows a user with mssp or admin privileges to delegate control to users individually or as a group. The group may be all the users of a LAN or WAN or one of a number of user groups in a network. A group could even extend across more than one network. An mssp user delegates admin privileges on a per administrator basis, but even administrators could have their delegated privileges controlled on a group basis under the permission model. Group control is particularly advantageous. For example, this allows an admin user to set a whitelist for a entire group of users, whereas a user user is only able to control their whitelist.

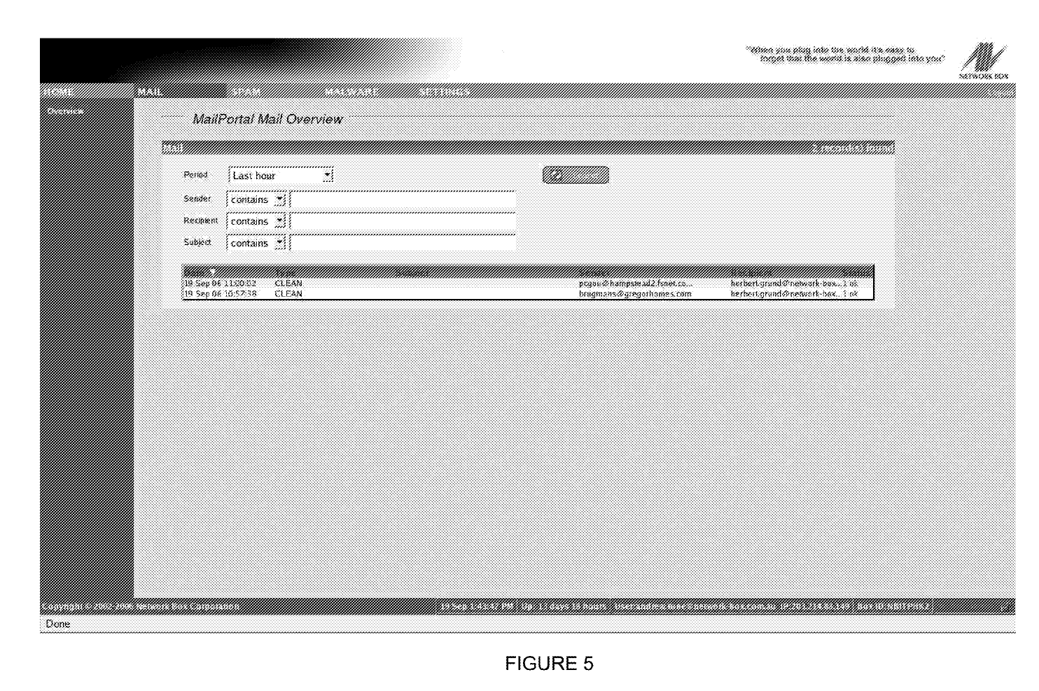

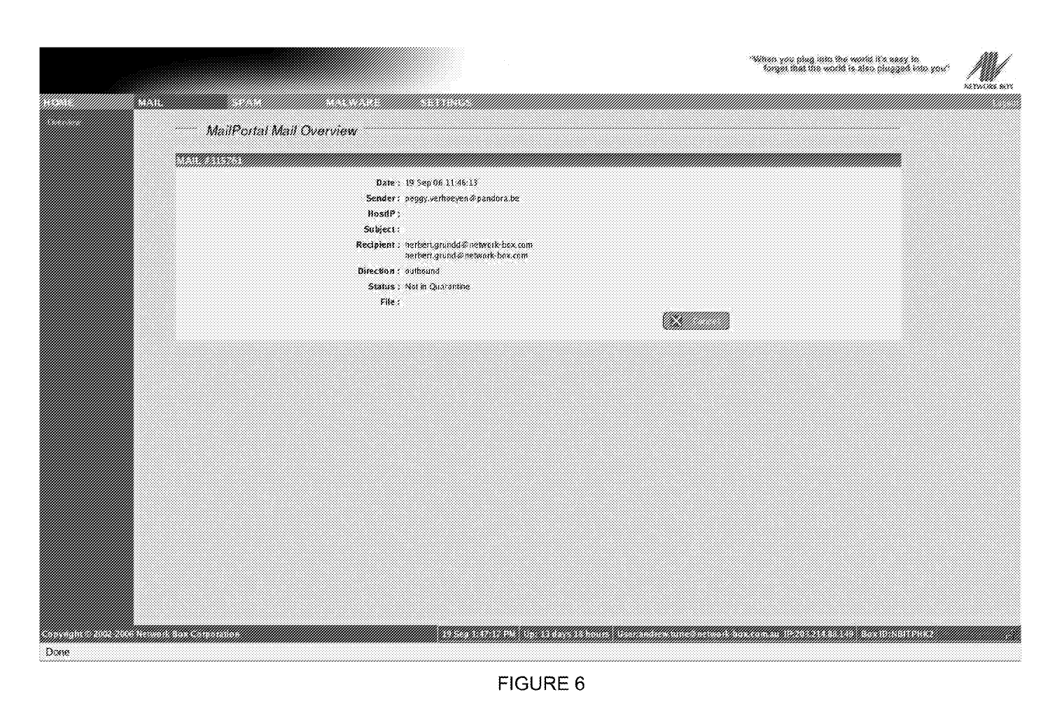

The control elements 312 to 318 are accessible via the interface of the administration module 310 using respective tab controls 500, 502, 504 of the interface. This provides access to the services based on the capability levels assigned for a user. For example, selecting the mail tab 502 provides an interface to the search service, as shown in FIG. 5, of the mail control element 312. This allows a user on a terminal 110 to search emails that have been processed by the security server 100 within a given period based on search fields that are available according to the associated capability level. The results are displayed and an individual message can be selected so as to then display the meta data associated with the message, as shown in FIG. 6. Again, based on the capability level, mail can then be dealt with, such as deleted, released or otherwise.

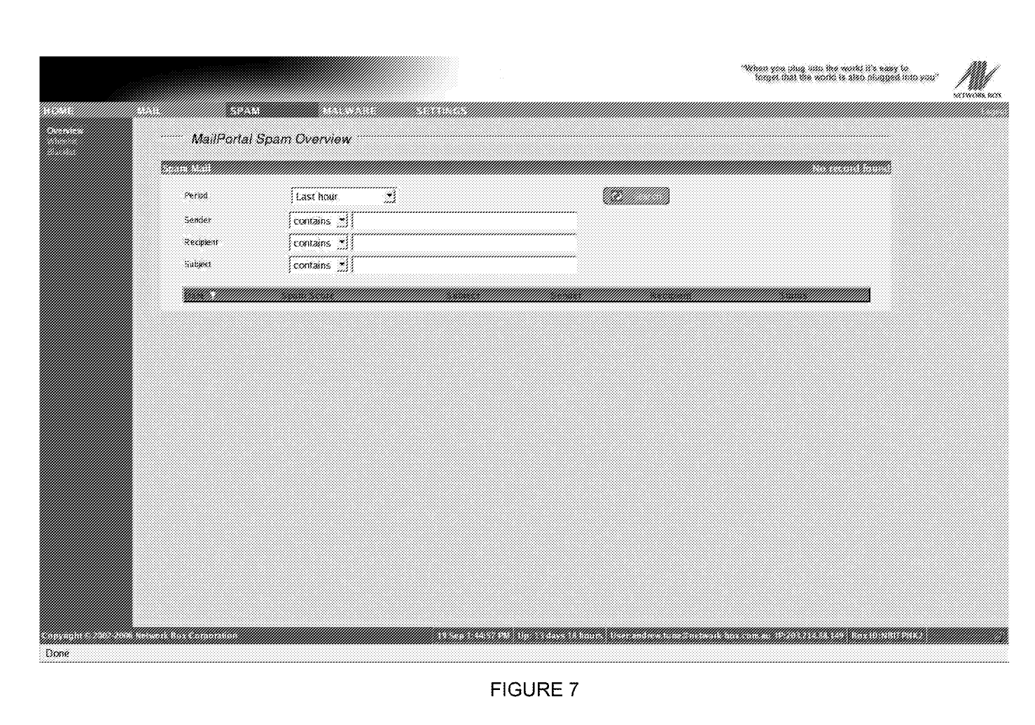

Similarly, by selecting the spam control tab 500, an interface to services of the spam control element 314 is generated, such as shown in FIG. 7. A search service allows spam messages trapped by the spam filters of the box 100 to be searched, on the basis of fields available according to the associated capability level, as shown in FIG. 7. If the capability is set to a level that provides access to an interface to a filter service, then parameters for the spam filters can be set using the user's terminal 110. Normally this capability would only be set to allow access to a user that has an admin permission attribute for the spam control element 314, but it could also be granted to a user with a user attribute. The results of searches for spam messages are displayed, and an individual message can be selected so as to review the meta data. Based on the capability level, the message can then be released. For a user permission attribute, the associated release capability level may be set to allow encapsulated release whereby when the email is released from the box 100 to the terminal 110, it is sent as an attachment to a cover email that explains the nature of the release. For example, it may state “the attached email arrived for you on . . . and was released by . . . at . . . ”. A more restricted higher level release capability attribute allows access to a raw release process whereby when a selected the email is released it is sent directly to an inbox of the user, as if it had not been intercepted by the box 100.

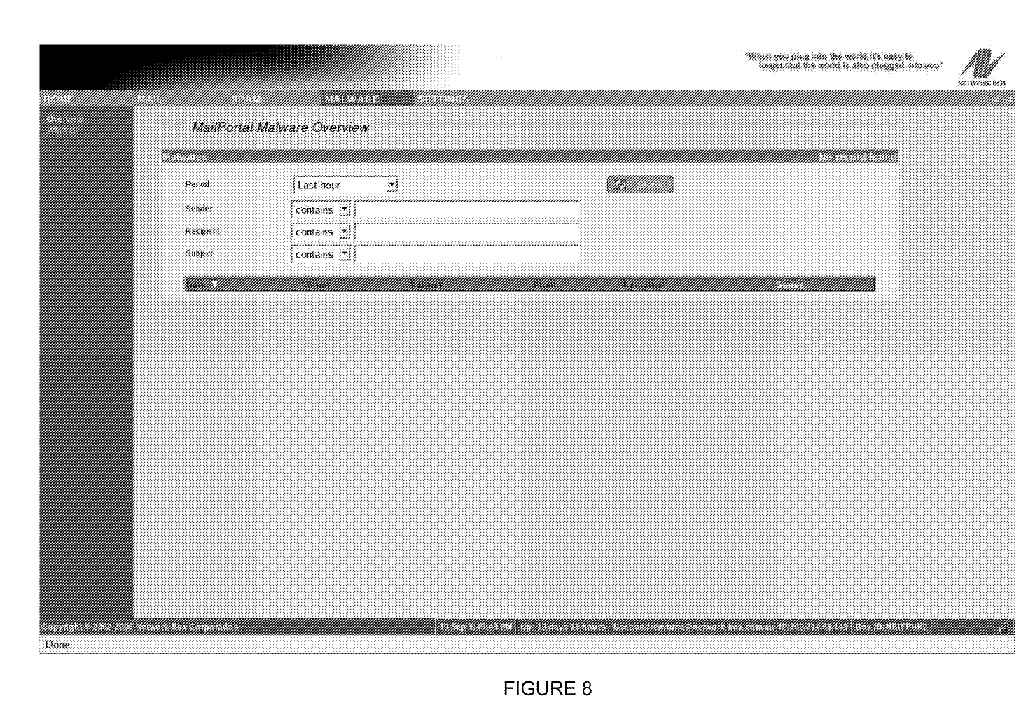

Selecting the malware control tab 504 provides access to an interface to malware services of the malware control element 316, as shown in FIG. 8, based again on the capability level. This is similar to that for the spam control element 314, except that only malware messages are accessible. The capability levels would also normally be set so that raw access to messages is even further restricted.

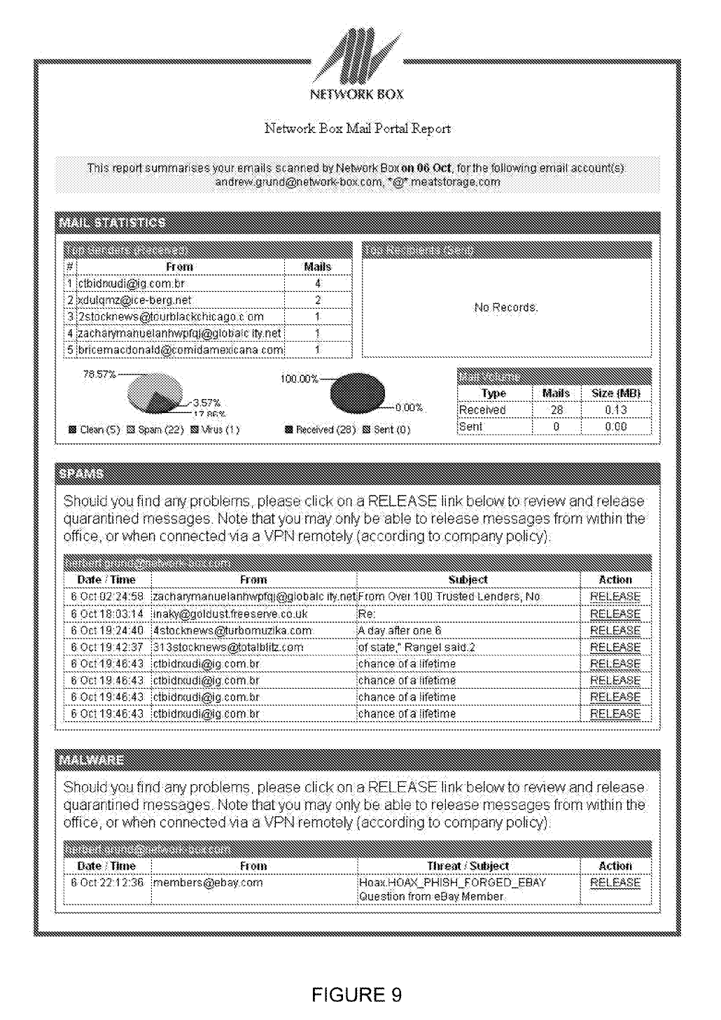

A user may be given access to the report services of the control elements 312 to 318 and have capability levels set that provides access to parameters that control not only the manner in which the report components on the overview interface is displayed, but also the timing and manner in which reports are emailed to a user's inbox. For example, FIG. 9 illustrates a report that can be sent by the administration module 310 accessing selected services of the control elements 312 to 318. This provides a dynamic report on mail messages in general, and spam messages that have been trapped. The report also provides a HTTP release link for each spam message, that when activated sends a request to the security server 100 to release the message according to the user's release capability level attribute for the spam control element 314. The components 310 to 318 of the server 100, discussed above, are preferably implemented using computer program instruction code written in languages such as Perl, C, C++ and Java. The administration module also includes a web server, such as Apache, and Java Server Pages to deliver the dynamic and static interface components Alternatively, the processes performed by the components 310 to 316 may be implemented at least in part by dedicated hardware circuits, such as ASICs or FPGAs.

The administration portal provided by the security server 100 is particularly advantageous in that it allows individual control elements to be delegated from an MSSP to an administrator and then to individual users in the network. Allocating capability level attributes to the respective services and processes provided by the control elements provides a further level of restriction and control associated with the delegation. The ability to assign the attributes on a group basis is also advantageous. The portal allows the integrity of the security system to be maintained, whilst providing considerable flexibility in the degree to which users on a network are able to control network security services and delivery of network messages.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An administration portal for a network security server, including:
control elements allowing a user of a network to access respective services performed by said security server; and
an administration module for maintaining permission attributes for users of the network, said attributes defining access to said control elements.

2. An administration portal as claimed in claim 1, wherein said permission attributes have a delegation hierarchy wherein a managed security service provider can set a permission attribute for a user to administrator, and the user with an administrator permission attribute can set another user to have a user permission attribute.

3. An administration portal as claimed in claim 2, wherein the permission attributes can be set on a group basis for a group of said users.

4. An administration portal as claimed in claim 2, wherein the attributes are respectively associated with said control elements.

5. An administration portal as claimed in claim 4, wherein the attributes each have associated capability levels defining a level of access for the respective services.

6. An administration portal as claimed in claim 5, wherein the capability level determines whether the user is allowed to set parameters for the associated services.

7. An administration portal as claimed in claim 5, wherein the capability level determines interface components viewable and accessible by the user on an interface generated by the portal.

8. An administration portal as claimed in claim 1, wherein the control elements include a mail control element providing access a search service to search emails that have been processed by the security server.

9. An administration portal as claimed in claim 8, wherein at least one capability level determines search fields available to a user of the search service.

10. An administration portal as claimed in claim 8, wherein at least one capability level determines data associated with the message that can be displayed.

11. An administration portal as claimed in claim 1, wherein control elements include a spam control element providing access to one or more of filter, release, search, blacklisting and whitelisting services.

12. An administration portal as claimed in claim 11, wherein at least one capability level determines whether the user is able to set parameters of a spam filter service of the spam control element.

13. An administration portal as claimed in claim 1, wherein the control elements include a malware control element providing access to one or more of malicious email filter, release and search services.

14. An administration portal as claimed in claim 1, wherein the control elements include a web browser control element providing access to HTTP response filter and report services.

15. An administration portal as claimed in claim 1, wherein report services of the control elements generate and send a report interface to a user, associated with an administrator permission attribute, for a group of users of the network.

16. A network security system including:
a managed security service provider,
at least one network security server, and
an administration portal for the at least one network security server, including:
control elements allowing a user of a network to access respective services performed by said security server; and
an administration module for maintaining permission attributes for users of the network, said attributes defining access to said control elements.

17. An administration process for a network security server, including:
allowing a user of a network to access respective services performed by said security server; and
maintaining permission attributes for users of the network, said permission attributes defining access to said services and having a delegation hierarchy;
wherein a managed security service provider can set a permission attribute for a user to administrator, and a user with an administrator permission attribute can set another user to have a user permission attribute.

18. An administration process for a network security server as claimed in claim 17, including setting the permission attributes on a group basis for a group of said users.

19. An administration process for a network security server as claimed in claim 17, wherein the attributes are respectively associated with said control elements.

20. An administration process for a network security server as claimed in claim 19, including setting associated capability levels for the attributes to define a level of access for the respective services.

21. An administration process for a network security server as claimed in claim 20, wherein the capability level determines whether the user is allowed to set parameters for the associated services.

22. An administration process for a network security server as claimed in claim 20, wherein the capability level determines interface components viewable and accessible by the user on an interface generated by the portal.

23. An administration process for a network security server as claimed in claim 17, wherein the services include a mail search service to search emails that have been processed by the security server.

24. An administration process for a network security server as claimed in claim 23, wherein at least one capability level determines search fields available to a user of the search service.

25. An administration process for a network security server as claimed in claim 23, wherein at least one capability level determines data associated with the message that can be displayed.

26. An administration process for a network security server as claimed in claim 17, wherein the services include at least one of spam filter, release, search, blacklisting and whitelisting services.

27. An administration process for a network security server as claimed in claim 26, wherein at least one capability level determines whether the user is able to set parameters of a spam filter service.

28. An administration process for a network security server as claimed in claim 17, wherein the services include at least one of malicious email filter, release and search services.

29. An administration process for a network security server as claimed in claim 17, wherein the services include HTTP response filter and report services.

30. An administration process for a network security server as claimed in claim 17, including generating and sending a report interface to a user, associated with an administrator permission attribute, for a group of users of the network.
